(19) United States
(12) Patent Application Publication
(10) Pub. No.: US 2016/0227320 A1
(43) Pub. Date: Aug. 4, 2016

(54) MULTI-CHANNEL MICROPHONE MAPPING

(71) Applicant: WOLFSON DYNAMIC HEARING PTY LTD, Cremorne, Victoria (AU)

(72) Inventors: Thomas Ivan Harvey, Cremorne, Victoria (AU); Vitaliy Sapozhnykov, Cremorne, Victoria (AU)

(73) Assignee: Wolfson Dynamic Hearing Pty Ltd., Cremorne, Victoria (AU)

(21) Appl. No.: 15/021,289

(22) PCT Filed: Sep. 10, 2014
(86) PCT No.: PCT/AU2014/000890

§ 371 Date: Mar. 11, 2016

(30) Foreign Application Priority Data
Sep. 12, 2013 (AU) 2013903503

(51) Int. Cl. H04R 5/027; H04R 5/04; H04S 1/00

(52) U.S. Cl. CPC H04R 5/027; H04S 1/002; H04R 5/04; H04S 2400/15; H04S 2400/01

(57) ABSTRACT

A method of adaptively mapping a plurality of microphone signals to a multi-channel audio signal, for example to capture stereo audio from a device held in variable orientations. At least first and second microphone signals, from respective first and second spaced apart microphones, are obtained. A device orientation signal is also obtained from a device orientation sensor. The microphone signals are adaptively mapped, based on the device orientation signal, to produce a first audio signal channel of a multi-channel audio signal. The first and second microphone signals are also adaptively mapped, based on the device orientation signal, to produce a second audio signal channel of a multi-channel audio signal.

### CROSS-REFERENCE TO RELATED APPLICATIONS

This application claims the benefit of Australian Provisional Patent Application No. 2013903503 filed 12 Sep. 2013, which is incorporated herein by reference.

### TECHNICAL FIELD

The present invention relates to the digital processing of signals from microphones or other such transducers, and in particular relates to a device and method for mapping a plurality of such signals to produce a multi-channel recording, such as a stereo recording, in a manner which is responsive to an orientation in which a device bearing the microphones is held or positioned by a user.

### BACKGROUND OF THE INVENTION

Recording of multi-channel audio is widely used, for example in music and video recordings, in order to retain spatial cues for subsequent listeners. For example, the multi-channel audio may be in stereo with left and right channels, or may have a greater number of channels such as a surround sound “5.1” multi-channel audio recording. To record multi-channel audio requires that a plurality of microphones be positioned in a particular orientation relative to the audio source(s) being recorded. In the simplest case of two channels for a stereo recording, two microphones must be positioned laterally apart by a sufficient distance that the audio signal captured at each microphone when played back through respective stereo speakers will retain the spatial cues that allow a listener to perceive left/right directionality in the resulting audio playback. Similar microphone position requirements apply when capturing audio recordings with a greater number of channels, such as when including front/rear channels and/or above/below channels.

However, a large number of consumer devices now contain multiple microphones for taking an audio recording, often captured together with a video recording. Users of such devices can hold the device in any one of a number of orientations, as there is no single “correct way up” to use the device. Smart phones and point-and-shoot cameras are examples of such devices which can be held in any one of a number of orientations during audio recording. A user might choose to hold the device in a landscape orientation for some recordings, but in a portrait orientation for other recordings, or even using both orientations within a single recording. When using a touchscreen device, a user may hold a smartphone in a first landscape orientation or in a second landscape orientation rotated 180 degrees from the first landscape orientation; for example depending on whether the user is right handed or left handed. Accordingly it is not possible to preconfigure such devices with knowledge of the relative position of each microphone to the audio source being recorded. That is, it is not possible to “hard wire” one microphone to be connected to a left recording channel, for example, because in use the device might be rotated so that that microphone is in fact capturing right side audio when the device is in a reversed landscape orientation, or is capturing top-centre audio when the device is in a portrait orientation.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this specification, a statement that an element may be “at least one of” a list of options is to be understood that the element may be any one of the listed options, or may be any combination of two or more of the listed options.

### SUMMARY OF THE INVENTION

According to a first aspect the present invention provides a method of adaptively mapping a plurality of microphone signals to a multi-channel audio signal, the method comprising:

obtaining at least first and second microphone signals from respective first and second spaced apart microphones;

obtaining a device orientation signal from a device orientation sensor;

adaptively mapping the first and second microphone signals to produce a first audio signal channel of a multi-channel audio signal, based on the device orientation signal; and

adaptively mapping the first and second microphone signals to produce a second audio signal channel of a multi-channel audio signal, based on the device orientation signal.

The device orientation sensor may in some embodiments be onboard the device bearing the microphones, and may in some embodiments comprise a gyroscopic motion sensor or micro electro-mechanical system (MEMS) accelerometer.

The microphone signals may in some embodiments be obtained directly from the microphones, or may in some embodiments be obtained indirectly via an intermediate signal path such as via a digital signal processor and/or a digital signal storage device. When the microphone signals are obtained indirectly, a device orientation signal obtained contemporaneously with the microphone signals is preferably similarly stored and/or processed in order to provide a temporally appropriate device orientation signal.

The method may be performed substantially at the time that the microphone signals are sensed, and the multi-channel audio signal may be output to a recording medium, so as to record a multi-channel audio signal from the microphones. Alternatively, the method may be performed at a time after the microphone signals are sensed, such as by being performed upon a stored copy of the microphone signals, for example in order to produce a multi-channel audio signal at a later time such as at a time of signal playback.

In some embodiments of the invention, the adaptive mapping is based upon information or parameters which reflect the position of the microphones upon the specific device being used. The information or parameters which reflect the position of the microphones may in some embodiments specify or reflect a spacing between respective microphones of the device. For example, in the case of a smartphone, a lateral spacing between microphones in a landscape orientation may be about 122 mm whereas a lateral spacing between microphones in a portrait orientation may be about 64 mm. Such physical parameters are fixed at a time of product design and manufacture, and may therefore be known in advance and provided for use by software implementing the present invention. It is to be understood that a lateral spacing between microphones defines the path length difference in signals arriving at each microphone and that knowledge of the microphone spacing to the adaptive mapping process thus permits the adaptive mapping to operate in an appropriate manner for the microphone spacing being experienced as a result of the orientation in which the user chooses to hold the device. For example, in some embodiments a “stereo widening” process may be applied more aggressively when the device is in a portrait orientation in order to improve stereo effects which may otherwise be captured less effectively by closer-spaced microphones. Orientation of the device may similarly adaptively control parameters that control the operation of any spatial processing algorithm, such as beamforming or adaptive noise cancellation, to provide the most natural reproduction of the captured environment.

In some embodiments, the information or parameters which reflect the position of the microphones may additionally or alternatively specify or reflect a position of one or more microphones upon the device. For example, a smartphone bearing three-microphones may have first and second microphones near adjacent corners of the device at each end of a first short side of the device, and a third microphone substantially in the middle of a second short side of the device at an opposite end to the first short side. When the device orientation sensor indicates that the device is in a landscape mode, either or both of the first and second microphones may be adaptively mapped to one of a left-side and right-side stereo audio channel, with the third microphone being mapped to the other of the left-side and right-side stereo audio channel However, when the device orientation sensor indicates that the device is in a portrait orientation, the information or parameters which reflect the position of the microphones will indicate that the third microphone is in a central position and of less value to capture stereo than the first and second microphones, so that the adaptive mapping process can thus optimise stereo audio capture by adaptively mapping the first microphone to one of a left-side and right-side stereo audio channel and adaptively mapping the second microphone to the other of the left-side and right-side stereo audio channel.

In some embodiments, the information or parameters which reflect the position of the microphones may additionally or alternatively specify or indicate a surface within which the respective microphone is positioned, as a direction of sensitivity of the microphone may for example differ by 90 degrees or 180 degrees from other microphones and may be taken into account by the adaptive mapping process. It is noted that in many devices the microphone itself may be an omnidirectional microphone and that a direction of sensitivity of the microphone may be defined primarily by an associated port in the body of the device and in particular whether the port is in the front, side or back of the device. It is further noted that in such configurations the microphone may be substantially equally sensitive throughout a wide range of angles of arrival of sound, such as 180 degrees or more, and that in such embodiments the nominal direction of sensitivity of the microphone as used herein relates to a centre-point of such a range of arrival angles. In such embodiments, where the direction of sensitivity of a first microphone differs by 180 degrees from a second microphone, a spacing between the first and second microphones may be defined in the information or parameters which reflect the position of the microphones, and may in turn be used by the adaptive mapping process to produce signal channels which convey some sense of front/rear directionality and/or to adaptively control a beam steering algorithm, directional microphone or other noise reduction scheme. The spacing between the first and second microphones in such embodiments may be about the same as the thickness of the device, or may differ from the thickness of the device depending on the acoustic path around the device between the first and second microphones. In addition to, or alternatively to, the spacing between the first and second microphones, the information or parameters which reflect the position of the microphones may specify or indicate a predetermined relative time-of-arrival or inter-microphone acoustic delay for one or more device orientations.

Moreover, some such embodiments may define one of the first and second microphones as being a primary microphone based on which microphone is orientated toward the field of view. Where the device has both forward looking and rearward looking (user-facing) cameras, a parameter indicating which camera is recording at the time is preferably utilised by the adaptive mapping process in order to define that the primary microphone of a front/rear microphone pair is whichever microphone is orientated in the same direction as the camera in use.

The adaptive mapping of the present invention may in some embodiments be performed once only for each recording, in order to define a fixed microphone mapping for that recording based on the device orientation at or prior to the commencement of the recording. Such embodiments assume that the device is likely to be held in a single orientation for the entire duration of the recording.

Alternatively, the adaptive mapping of the present invention may in some embodiments be performed repeatedly or continuously throughout a recording, to permit the microphone mapping to change within the recording should the device orientation change. In such embodiments, changes in microphone mapping are preferably smoothed over a suitable transition period in order to avoid inappropriate listener perceptions which may arise from step changes or rapid changes in microphone mapping.

According to a second aspect the present invention provides a device configured to adaptively map a plurality of microphone signals to a multi-channel audio signal, the device comprising:

first and second spaced apart microphones for sensing sounds and producing respective first and second microphone signals;

a device orientation sensor for producing a device orientation signal;

an audio signal processor for adaptively mapping the first and second microphone signals to produce a first audio signal channel of a multi-channel audio signal, based on the device orientation signal, and for adaptively mapping the first and second microphone signals to produce a second audio signal channel of a multi-channel audio signal, based on the device orientation signal.

In some embodiments of the second aspect of the invention, the audio signal processor is a dedicated audio processing chip, or audio hub, separate to a general processor controlling other functions of the device. Such embodiments are advantageous in removing audio signal processing overhead from a main device processor.

According to another aspect the present invention provides computer software for carrying out the method of the first aspect.

According to another aspect the present invention provides a computer program product comprising computer program code means to make a computer execute a procedure for adaptively mapping a plurality of microphone signals to a multi-channel audio signal, the computer program product comprising computer program code means for carrying out the method of the first aspect.

Where the device provides functions other than multi-channel audio capture, such as a smartphone which is also able to provide mono-channel telephony for example, the present invention may be applied alongside such other functions in order to provide multi-channel microphone mapping in relation to those particular device functions which require retention of spatial cues in the audio signal being processed.

Where the device is equipped with multi-microphone processing, such as being equipped with a beamforming function or adaptive noise cancelling function, the adaptive mapping may in some embodiments be configured to hierarchically order the device's microphones depending on the device's orientation to produce appropriate inputs for the multi-microphone processing. Alternatively, if the device is not equipped with multi-microphone processing and a simple stereo output is required, the adaptive mapping may in some embodiments be configured to select, out of all of the device's microphone signals, the two signals which maximise spatial cue.

The device may in some embodiments comprise 2 microphones, 3 microphones, or 4 microphones, or indeed any practical number of microphones. The microphones may in some embodiments be located in any suitable positions on the device.

### BRIEF DESCRIPTION OF THE DRAWINGS

An example of the invention will now be described with reference to the accompanying drawings, in which:

FIG. 1 is a schematic of two possible device use modes in accordance with the present invention;

FIGS. 2a-2c illustrate a device in accordance with one embodiment of the present invention and a signal processing path thereof;

FIGS. 3a-3b illustrate an alternative signal processing path in accordance with another embodiment of the invention;

FIG. 4 illustrates a control module in accordance with an embodiment of the present invention;

FIGS. 5a and 5b illustrate the layout of microphones of a handheld device in accordance with one embodiment of the invention, in both possible landscape orientations;

FIG. 6 illustrates another microphone arrangement which may be adaptively mapped in accordance with the present invention;

FIG. 7 is a schematic of a system to record stereo audio for playback in accordance with an embodiment of the invention; and

FIG. 8 is a schematic of a system to record stereo audio for playback in accordance with another embodiment of the invention.

### DESCRIPTION OF THE PREFERRED EMBODIMENTS

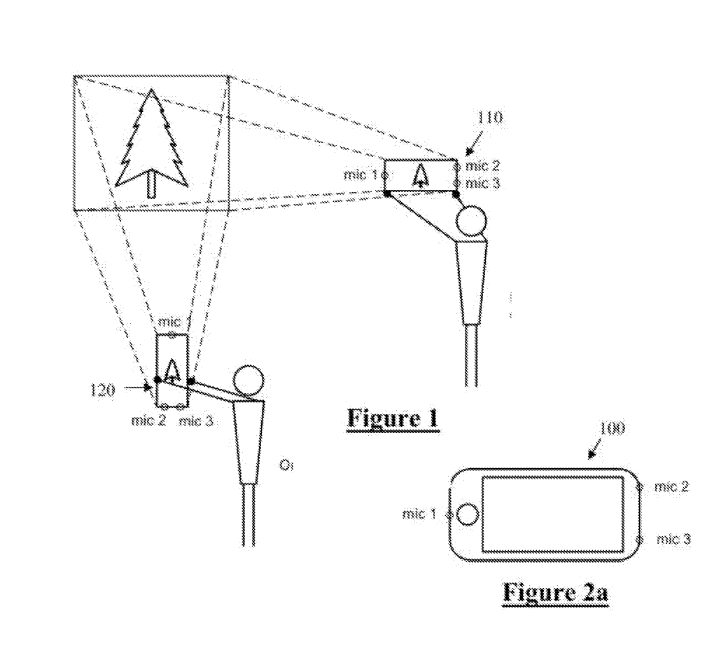

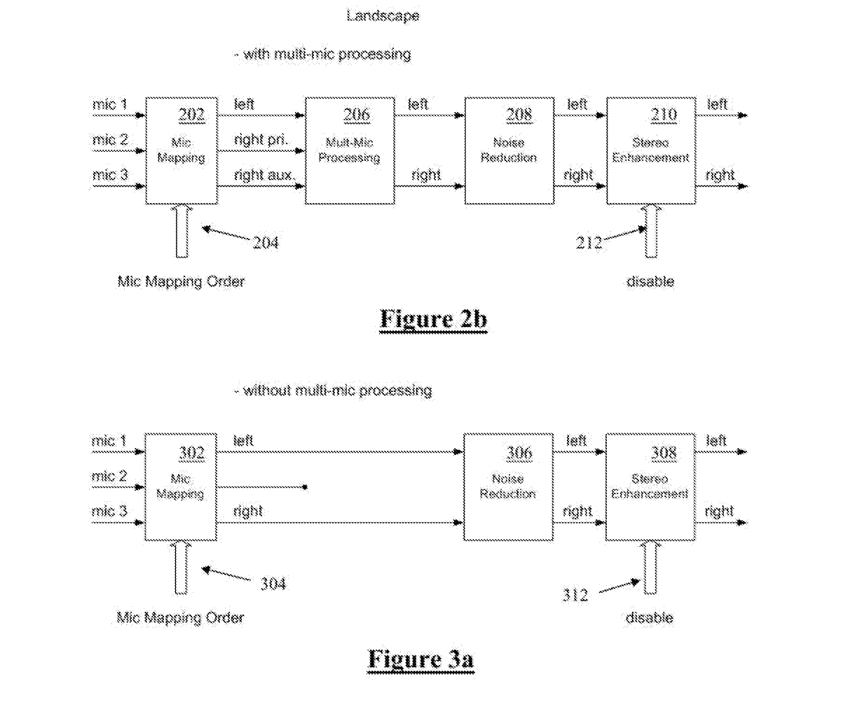

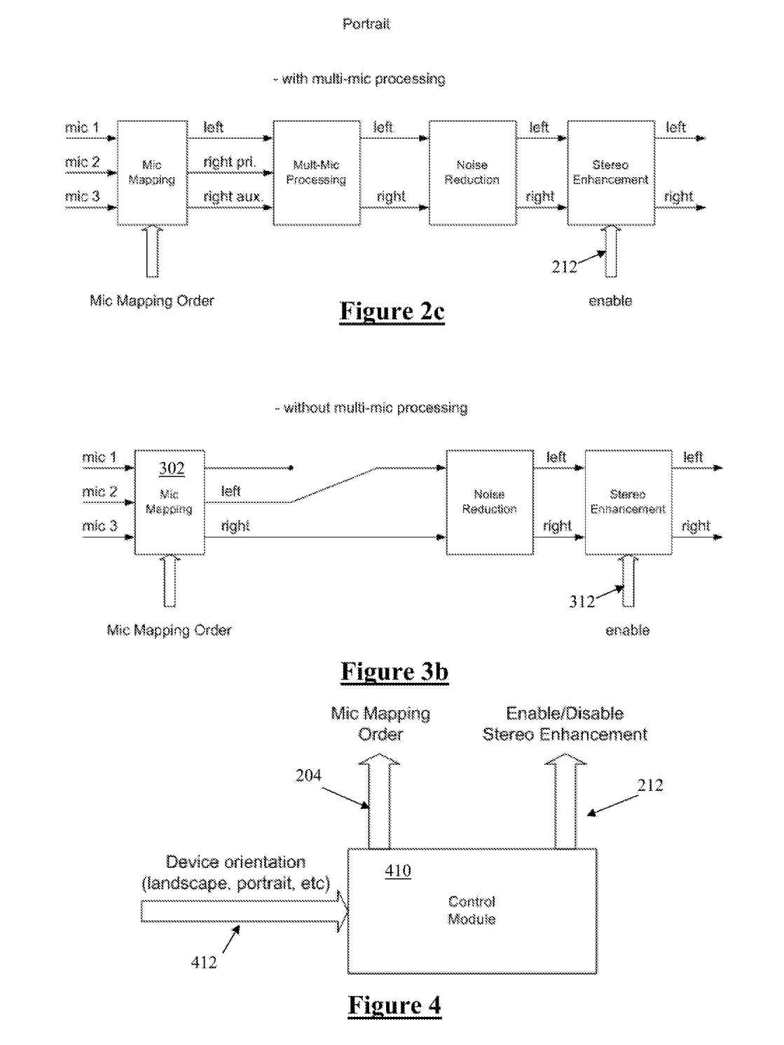

FIG. 1 is a schematic of two possible device use modes involving differing device orientations. In a first mode indicated at 110 the device is used in landscape mode, whereas in a second mode indicated at 120 the device is used in portrait mode. It is to be noted that the device use modes are not limited to said corner modes but could be represented by arbitrary (discrete or continuous) device orientations. In this described embodiment, a device 100 with 3 microphones configured as shown in FIG. 2a is used to illustrate the microphone mapping technique of this embodiment.

FIG. 2b represents a signal path of device 100. Knowledge of the device's orientation is obtained from an onboard gyroscope (not shown) of the device 100, to detect that the device 100 is in landscape orientation mode. According to this embodiment of the present invention, the knowledge of device orientation is expressed in terms of a Microphones Mapping Order 204 and a Stereo Enhancement Enable/Disable signal 212. The Microphone Mapping Block 202 has three signal inputs, one for each microphone, and also a control input. The control input is input with the Microphones Mapping Order 204. It is to be appreciated that the Microphones Mapping Order is application specific. According to one embodiment, the device's signal path is equipped with a Multi-Microphone Processing Block 206. The Multi-Microphone Processing Block 206 in this embodiment includes an adaptive noise canceller and adaptive beamformer. Thus, the Multi-Microphone Processing Block 206 requires ordering of the input signals. For example, the device's three microphones may be required to be ordered into one pair consisting of a primary and auxiliary microphone. To this end the Microphone Mapping Block 206 function is expressed as a mapping F(.) such that:

[left, right primary, right auxiliary]=F(mic 1, mic 2, mic 3, DO),

where DO is ‘device orientation’.

Similarly, in other embodiments relating to a 4-microphone device, the Microphone Mapping Block function may be expressed as follows:

[left primary, left auxiliary, right primary, right auxiliary]=F(mic 1, mic 2, mic 3, mic 4, DO).

The Multi-Microphone Processing Block 206 produces two output signals: left and right, which may undergo noise reduction in the Noise Reduction Block 208. Often, in the landscape orientation mode, modern devices have sufficient left and right microphone separation that no further enhancement of the spatial cue is required. Therefore in this embodiment in the landscape orientation mode 110 the Stereo Enhancement Block 210 is bypassed by sending it a ‘disable’ signal 212. In contrast, in FIG. 2c, the device 100 is in portrait mode 120 and so signal 212 is set to “enable” in order to cause stereo widening to be performed in order to compensate for the close spacing of microphone 2 and microphone 3 in portrait mode.

In another embodiment, FIGS. 3a and 3b illustrate the signal path of a device which does not have multi-microphone processing functions but does require implicit knowledge of the device's orientation. FIG. 3a shows the signal path when the device is in the landscape orientation mode 110. In this embodiment, the knowledge of device orientation is again expressed in terms of a Microphones Mapping Order 304 and a Stereo Enhancement Enable/Disable signal 312. The Microphone Mapping Block 302 has three signal inputs, one for each microphone, and a control input receiving the Microphones Mapping Order 304. Again, it is to be appreciated that the Microphones Mapping Order 304 is application specific.

The Multi-Microphone Mapping Block 302 produces two output signals: left and right. In the landscape mode 110 reflected in FIG. 3a, mic 1 is mapped to the “left” signal by block 302, and mic 3 is mapped to the “right” signal by block 302. The left and right signals may then undergo noise reduction in the Noise Reduction Block 306.

On the other hand, when device 100 is held in portrait orientation mode 120, mic 2 is mapped to the “left” signal and mic 3 is mapped to the “right” signal by block 302 as shown in FIG. 3b. A distance mic 2 and mic 3 is about half the distance between mic 1 and mic 3. Accordingly, in the portrait orientation mode 120, device 100 does not have sufficient left and right microphone separation. Therefore, when the device is in the portrait orientation mode, to maintain spatial cues stereo enhancement is enabled as shown at 312 in FIG. 3b. A suitable stereo enhancement process is carried out by the Stereo Enhancement Block 308. Thus, in the portrait orientation mode 120, the Stereo Enhancement Block is enabled by sending it an ‘enable’ signal 312 as shown in FIG. 3b.

FIG. 4 represents a Control Module 410 which determines the Mic Mapping Order 204 and Enable/Disable Stereo Enhancement 212 signals and supplies them to the corresponding blocks (e.g. Multi-Microphone Processing 206 and Stereo Enhancement 210). The Control Module 410 has Device Orientation (DO) 412 as its input. It outputs Mic Mapping Order 204 using application specific mapping F(.), and Enable/Disable Stereo Enhancement flag 212 based on a predefined physical microphone separation.

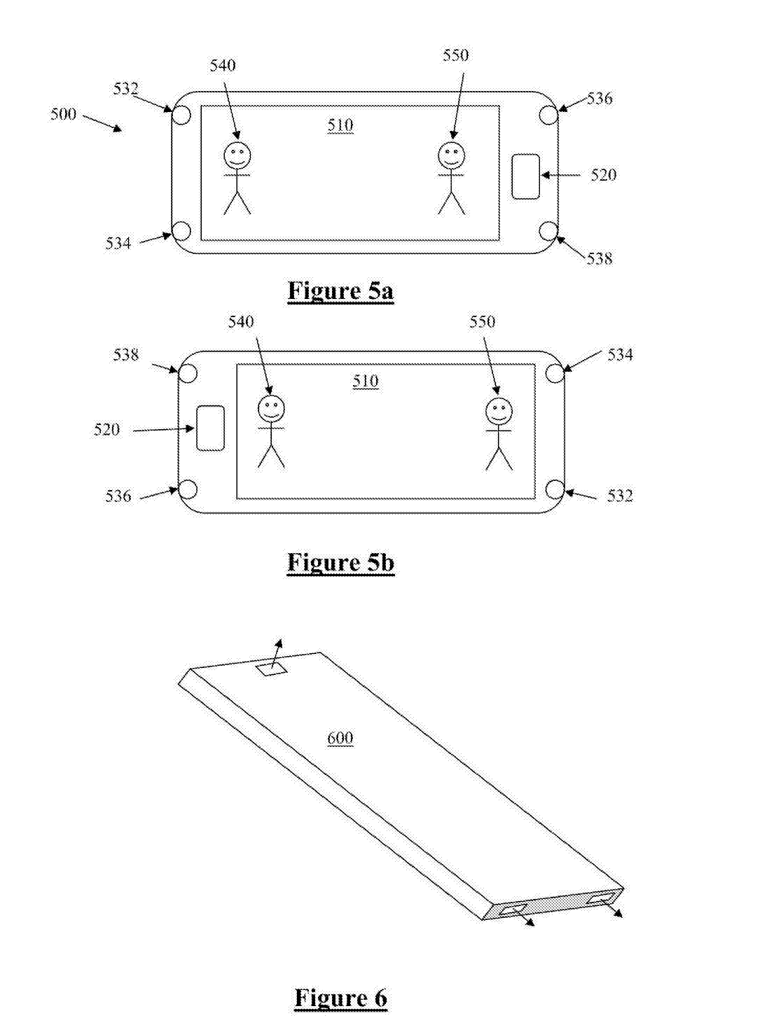

FIG. 5 illustrates a handheld device 500 with touchscreen 510, button 520 and microphones 532, 534, 536, 538. The following embodiments describe the capture of stereo audio using such a device, for example to accompany a video recorded by a camera (not shown) of the device. In a “right-handed” landscape orientation as shown in FIG. 5a, one or both of microphones 532 or 534 are positioned closest to a left-side audio source 540 while microphones 536 and 538 are positioned closest to a right-side audio source 550. However, in an opposite “left-handed” landscape orientation as shown in FIG. 5a, microphones 536 and 538 are now positioned closest to the left-side audio source 540 whereas microphones 532 and 534 are positioned closest to the right-side audio source 550. The microphone mapping of the embodiments of FIGS. 2 and 3 is configured to appropriately map the microphone inputs to allow for such opposed landscape orientations of the device 500.

FIG. 6 illustrates a device 600 in which three microphones are mounted, but on differing surfaces of the device. A direction from which audio signals may arrive unimpeded is indicated for each microphone. Sound may be occluded in an alternative manner at each microphone, and this may be a parameter taken into account when mapping microphones in accordance with embodiments of the present invention.

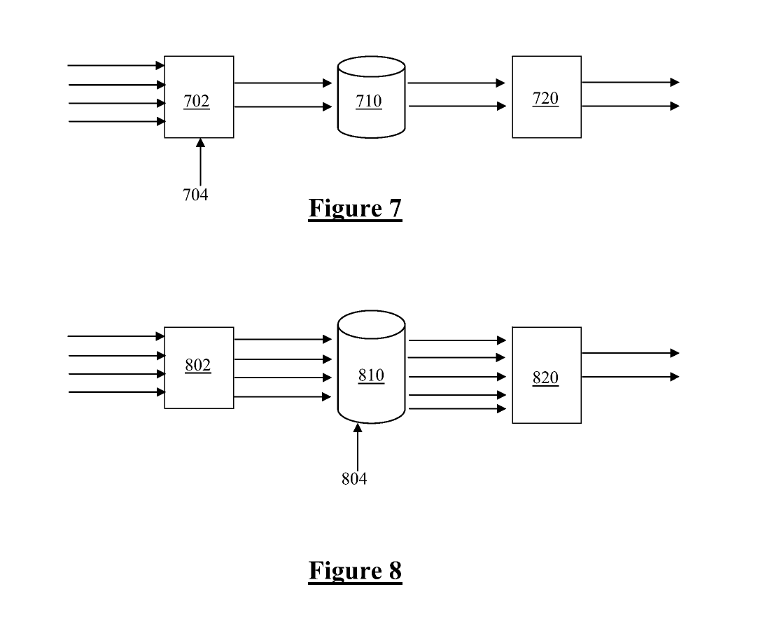

FIG. 7 illustrates a system schematic for an embodiment in which the present invention is used to record stereo audio for playback. Four microphones' signals are mapped and used by block 702 in accordance with the present invention, and based upon a device orientation signal 704, to produce L and R channels which are stored in store 710. Stereo audio so stored may be played back from store 710 by a playback device 720 at a later time.

FIG. 8 illustrates an alternative embodiment of the present invention. In FIG. 8 four microphone signals are processed by block 802, but independent of device orientation. The processed microphone signals and a device orientation signal are stored in store 810. At a later time, when it is desired to play back a stereo audio signal, the four microphone signals and the contemporaneously obtained device orientation signal 804 are passed to a playback device 820 which carries out a method in accordance with the present invention in order to produce appropriate left and right stereo channels for a listener. This embodiment may be advantageous in applying the present invention within block 820, even where the device 802 is not configured to perform the invention. Rather the embodiment of FIG. 8 merely requires that a device orientation signal 804 be contemporaneously obtained.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of adaptively mapping a plurality of microphone signals to a multi-channel audio signal, the method comprising:
obtaining at least first and second microphone signals from respective first and second spaced apart microphones;
obtaining a device orientation signal from a device orientation sensor;
adaptively mapping the first and second microphone signals to produce a first audio signal channel of a multi-channel audio signal, based on the device orientation signal; and
adaptively mapping the first and second microphone signals to produce a second audio signal channel of a multi-channel audio signal, based on the device orientation signal.

2. The method of claim 1 wherein the device orientation sensor is onboard the device bearing the microphones.

3. The method of claim 1, wherein the microphone signals are obtained directly from the microphones.

4. The method of claim 1, further comprising outputting the multi-channel audio signal to a recording medium, so as to record a multi-channel audio signal from the microphones.

5. The method of claim 1, wherein the microphone signals are obtained indirectly via an intermediate signal path, and wherein a device orientation signal obtained contemporaneously with the microphone signals is used in the mapping.

6. The method of claim 5, when performed upon a stored copy of the microphone signals in order to produce a multi-channel audio signal at a time of signal playback.

7. The method of claim 1, wherein the adaptive mapping is based upon parameters which reflect the position of the microphones.

8. The method of claim 1, wherein the mapping includes a stereo widening process which is applied more aggressively when the device orientation signal indicates that the device is in a portrait orientation.

9. The method of claim 1 wherein the mapping includes using the device orientation signal to control the operation of a beamforming algorithm.

10. The method of claim 1 wherein the mapping includes using the device orientation signal to control the operation of adaptive noise cancellation.

11. The method of claim 1, wherein the adaptive mapping is based upon parameters which indicate a predetermined relative time-of-arrival or inter-microphone acoustic delay for one or more device orientations.

12. The method of claim 1 wherein the mapping comprises defining that a primary microphone of a front/rear microphone pair is whichever microphone is orientated in the same direction as a camera in use.

13. The method of claim 1 wherein the mapping is performed once only for each recording, in order to define a fixed microphone mapping for that recording based on the device orientation at or prior to the commencement of the recording.

14. The method of claim 1 wherein the mapping is performed repeatedly or continuously throughout a recording, to permit the microphone mapping to change within the recording should the device orientation change.

15. The method of claim 14 wherein changes in microphone mapping are smoothed over a suitable transition period in order to avoid inappropriate listener perceptions which may arise from step changes or rapid changes in microphone mapping.

16. A device configured to adaptively map a plurality of microphone signals to a multi-channel audio signal, the device comprising:
first and second spaced apart microphones for sensing sounds and producing respective first and second microphone signals;
a device orientation sensor for producing a device orientation signal;
an audio signal processor for adaptively mapping the first and second microphone signals to produce a first audio signal channel of a multi-channel audio signal, based on the device orientation signal, and for adaptively mapping the first and second microphone signals to produce a second audio signal channel of a multi-channel audio signal, based on the device orientation signal.

17. The device of claim 16 wherein the audio signal processor is a dedicated audio processing chip.

18. A computer program product comprising non-transitory computer program code means to make a computer execute a procedure for adaptively mapping a plurality of microphone signals to a multi-channel audio signal, the computer program product comprising:
computer program code means for obtaining at least first and second microphone signals from respective first and second spaced apart microphones;
computer program code means for obtaining a device orientation signal from a device orientation sensor;
computer program code means for adaptively mapping the first and second microphone signals to produce a first audio signal channel of a multi-channel audio signal, based on the device orientation signal; and
computer program code means for adaptively mapping the first and second microphone signals to produce a second audio signal channel of a multi-channel audio signal, based on the device orientation signal.
